(19) United States
(12) Patent Application Publication
(10) Pub. No.: US 2013/0242077 A1
(43) Pub. Date: Sep. 19, 2013

(54) IMAGE CONTROL SYSTEM ABLE TO DETECT ELECTROOCULOGRAPHY

(71) Applicants: Chin-Teng LIN, Hsinchu County (TW); Zhong-Ho Chen, Taichung City (TW); Lun-De Liao, Taichung City (TW); I-Jan Wang, Kaohsiung City (TW)

(72) Inventors: Chin-Teng LIN, Hsinchu County (TW); Zhong-Ho Chen, Taichung City (TW); Lun-De Liao, Taichung City (TW); I-Jan Wang, Kaohsiung City (TW)

(21) Appl. No.: 13/542,265

(22) Filed: Jul. 5, 2012

(30) Foreign Application Priority Data
Mar. 16, 2012 (TW) 101109164

(51) Int. Cl. H04N 7/18

(52) U.S. Cl. 348/78; 348/E07.085

(57) ABSTRACT

An image control system able to detect electrooculography (EOG) is provided. The system detects EOG signals of a user through an electrooculography detection device and wirelessly transmits the signals to an external signal processing device. The external signal processing device calculates a position the user is staring at according to the signal received and presents on a display unit a sharp image of the position. Thereby, the present invention makes the user enjoy the feeling of watching real objects although the user is viewing a photo presented on the display in fact. Thus is optimized the visional quality in viewing photos.

### BACKGROUND OF THE INVENTION

1. Field of the Invention

The present invention relates to an image control system, particularly to an image control system able to detect electrooculography.

2. Description of the Related Art

Vision is the most important sense of human beings, providing 80-90% of the information a person receives all his life. Therefore, advance of vision technology influences us in every respect. Nowadays, a work requires exponentially-growing education level and professional skill. Thus, computer-using population is fast expanding. With popularization of computers, activities for collecting vision-related information are also growing explosively. Computers have become an important medium of information and communication.

In photography, “depth of field (DOF)” refers to the distance between the nearest and farthest objects in a scene that appear acceptably sharp in an image. Objects outside of the filed will appear blurry in the image. DOF depends on the focal length of a lens, the aperture and focusing distance in a shoot. In shooting a scene, the lens has a fixed focal length and aperture but there are several objects whose distances to the lens are different. Therefore, there are sharp and blurry objects coexisting in an captured image. When a person views the captured image in the monitor, he sees sharp and blurry objects. Such a case is very different from the case that the person views real objects. When a person views real objects and stares at a specified object, his eyes can automatically adjust the focal length. Therefore, when a person views real objects, he can always see the objects clearly.

In order to overcome the problem of DOF, a person has to take several images with different DOFs. For example, a multifocal camera is used to take several images of a scene at the same time, and the images respectively have different focusing points. If DOFs of the images cover all objects in the scene, all the objects respectively can appear sharp in different images.

Although current technology can take multifocal photos, current image display technology cannot switch the photos to a sharp one according to the object the user is staring at. The user cannot see a sharp object in the image presented by the current image display technology unless a complicated process is used. Therefore, how to directly present on a display device a sharp image of the object the user is staring at is a problem the field concerned desires to solve.

Accordingly, the present invention proposes an image control system able to detect electrooculography to overcome the abovementioned problem.

### SUMMARY OF THE INVENTION

The primary objective of the present invention is to provide an image control system able to detect electrooculography (EOG), which stores a great quantity of photos respectively having different DOFs and uses EOG eyeglasses to detect EOG signals, and which processes the EOG signals to determine where the user is staring at and then presents the sharp image of stared region, whereby the present invention is exempted from the complicated task of processing a great amount of image information and able to present the desired image precisely and effectively.

Another objective of the present invention is to provide an image control system able to detect EOG, which uses convenient-to-wear EOG eyeglasses to detect the EOG signals of the user, whereby to instantly present the sharp image the user is intending to watch and optimize the visional quality.

A further objective of the present invention is to provide an image control system able to detect EOG which enables the user to express himself via a human-machine interface, and which is applied to many fields, such as 3D images, video, biomedicine, etc, whereby is convenienced the living and assisted the disabled, wherefore it has very high potential in the market.

To realize abovementioned objectives, the present invention proposes an image control system able to detect EOG, which comprises an EOG detection device and an external signal processing device. The EOG detection device includes an eyeglass frame, a dry electrode module and a signal control module. The dry electrode module has a plurality of dry electrodes arranged in the eyeglass frame. One of the dry electrodes functions as a reference dry electrode. After the user wears the eyeglass frame, the dry electrode module detects analog EOG signals from the user, i.e. the voltage drop signals between the dry electrodes. The signal control module is arranged on the eyeglass frame and electrically connected with the dry electrode module. The signal control module amplifies and converts analog EOG signals into digital EOG signals and then outputs the digital EOG signals to the external signal processing device for succeeding signal processing. The external signal processing device includes a storage unit, a signal processing unit and a display unit. The storage module stores a plurality of pieces of image information. The signal processing unit electrically connects with the storage unit, works out where the user is staring at according to the digital EOG signals, and retrieves from the storage unit a sharp image corresponding to the stared region. The display unit electrically connects with the signal processing unit and presents the sharp image. Thereby, the present invention can present photos respectively captured in different focusing distances according to where the user is staring at. No matter where the user is staring at, the display unit always presents a sharp image of the stared region. Therefore, the system of the present invention enables the user to enjoy a feeling of closely watching real objects although he is viewing photos on a display device in fact.

Below, embodiments are described in detail to make easily understood the objectives, technical contents, characteristics and accomplishments of the present invention.

### BRIEF DESCRIPTION OF THE DRAWINGS

FIG. 1 shows the circuit architecture of an image control system able to detect EOG according to one embodiment of the present invention;

FIG. 2 schematically shows an EOG detection device worn on a human face according to one embodiment of the present invention;

FIG. 3 shows the detailed circuit architecture of an image control system able to detect EOG according to one embodiment of the present invention;

FIGS. 4a-4d schematically show the initialization steps of an image control system able to detect EOG according to one embodiment of the present invention; and

FIG. 5 schematically shows that a user operates an image control system able to detect EOG to present a sharp image of an object according to one embodiment of the present invention.

### DETAILED DESCRIPTION OF THE INVENTION

Eyeglasses are usually used to improve eyesight or prevent sunlight. As eyeglasses are easy to wear and carry about, they are widely used in daily life. Considering the convenience of eyeglasses, the present invention installs an EOG detection device in eyeglasses and utilizes the EOG detection device and an external signal processing device to realize eye-controlled image processing. The present invention will bring many possibilities for the future life.

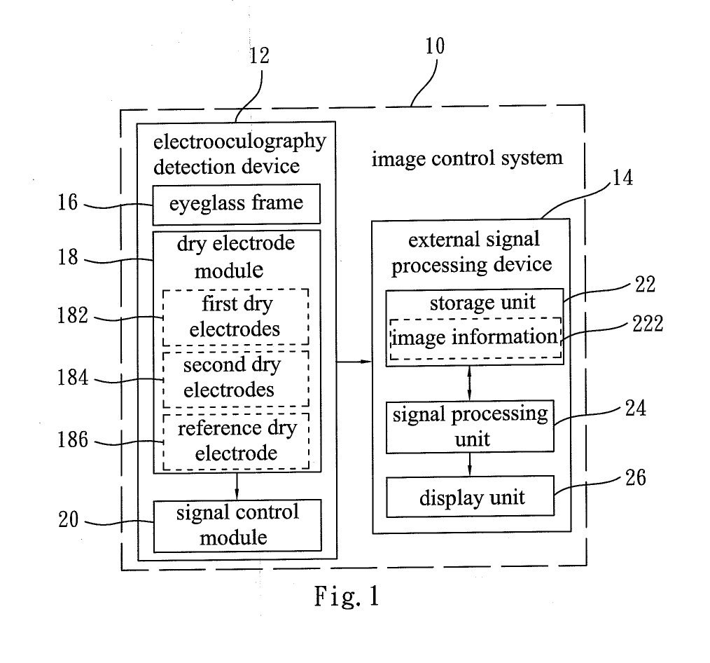

Refer to FIG. 1 for the circuit architecture of an image control system able to detect EOG according to one embodiment of the present invention. The image control system 10 of the present invention comprises an EOG detection device 12 and an external signal processing device 14. The EOG detection device 12 includes an eyeglass frame 16, a dry electrode module 18 and a signal control module 20. The dry electrode module 18 is a physiological sensor arranged in the eyeglass frame 16 and detecting EOG signals for tracking the movement of eyeballs.

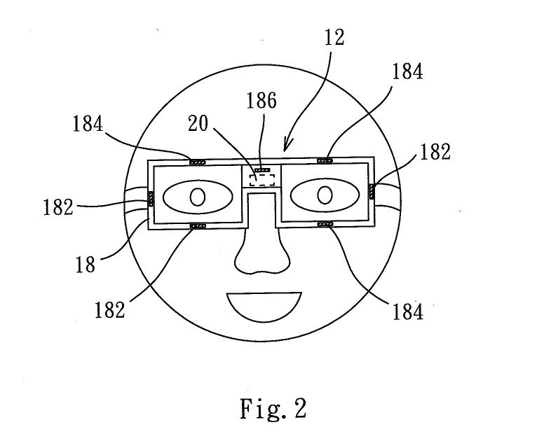

Refer to FIG. 2 a diagram schematically showing the EOG detection device 12 worn on a human face according to one embodiment of the present invention. The dry electrode module 18 has at least two first dry electrodes 182 and at least two second dry electrodes 184 and a reference dry electrode 186. Two first dry electrodes 182 is arranged in the left side and right side of the eyeglass frame 16. Two second dry electrodes 184 are arranged in the upper side and lower side of the eyeglass frame 16. The reference dry electrode 186 is preferably arranged in the middle of the eyeglass frame 16, functioning as a ground electrode. After the user wears the eyeglass frame 16 on his face, two first dry electrodes 182 detects the analog EOG signals of the horizontal movements of eyeballs, and two second dry electrode-couple 184 detects the analog EOG signals of the vertical movements of eyeballs. The analog EOG signals are worked out according to the potential difference between two first dry electrodes 182, the potential difference between two second dry electrodes 184, or the potential difference between the above-mentioned dry electrodes.

The signal control module 20 is arranged in the eyeglass frame 16. Preferably, the signal control module 20 is arranged in the middle of the eyeglass frame 16, so that every dry electrode can electrically connect with the signal control module 20 in the simplest way. The signal control module 20 amplifies the analog EOG signals of horizontal and vertical movements of eyeballs, converts the analog EOG signals into digital EOG signals, and then outputs the digital EOG signals to the external signal processing device 14, such a handheld communication device (mobile phone), a personal computer, a tablet computer, a notebook computer, etc.

The external signal processing device 14 includes a storage unit 22, a signal processing unit 24 and a display unit 26. The storage module 22 stores a plurality of pieces of image information 222. When an ordinary camera captures photos of a scene, the objects at different distances from the camera would be sharp or blurred in the captured photos, which should affect the visional quality when the user views the captured photos. Benefiting from the multifocal image-capturing device, the present invention stores in the storage unit 22 as the image information 222 a plurality of photos captured for an identical scene at different focusing distances at the same time. Thus, an object in the scene can always have a sharp image in one of captured photos. The signal processing unit 24 electrically connects with the storage unit 22 and the display unit 26, works out where the user is staring at according to the digital EOG signals, retrieves from the storage unit 22 a sharp image of the stared region, and presents the sharp image on the display unit 26.

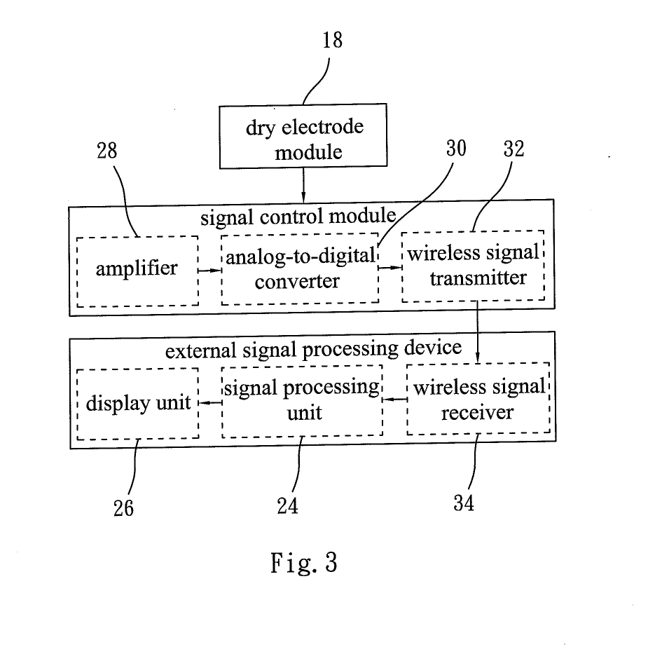

The EOG detection device 12 and the external signal processing device 14 intercommunicate in a wired or wireless way. Refer to FIG. 3 for the circuit architecture of the EOG detection device and the external signal processing device intercommunicating wirelessly according to one embodiment of the present invention. The signal control module 20 of the EOG detection device 12 further comprises an amplifier 28, an analog-to-digital converter 30, and a wireless signal transmitter 32. The dry electrode module 18 generates signals according to movement of eyeballs. As the analog EOG signals detected by the dry electrode module 18 are small, the amplifier 28 is used to amplify the analog EOG signals (e.g. by 1000 times). The analog-to-digital converter 30 electrically connects with the amplifier 28, converts the amplified analog EOG signals into digital EOG signals, filters out noise, and then transmits the digital EOG signals to the external signal processing device 14 via the wireless signal transmitter 32 for succeeding image processing. The wireless signal transmitter 32 may be realized by a WiFi transmitter or a Bluetooth transmitter. However, the present invention does not constrain that the signals must be transmitted in a WiFi way or a Bluetooth way. Any way able to transmit EOG signals wirelessly between the EOG detection device 12 and the external signal processing device 14 is also included within the scope of the present invention. The external signal processing device 14 further comprises a wireless signal receiver 34, such as a WiFi receiver or a Bluetooth receiver. The wireless signal receiver 34 electrically connects with the signal processing unit 24, receives the digital EOG signals wirelessly, and then outputs the digital EOG signals to the signal processing unit 24 for succeeding signal processing.

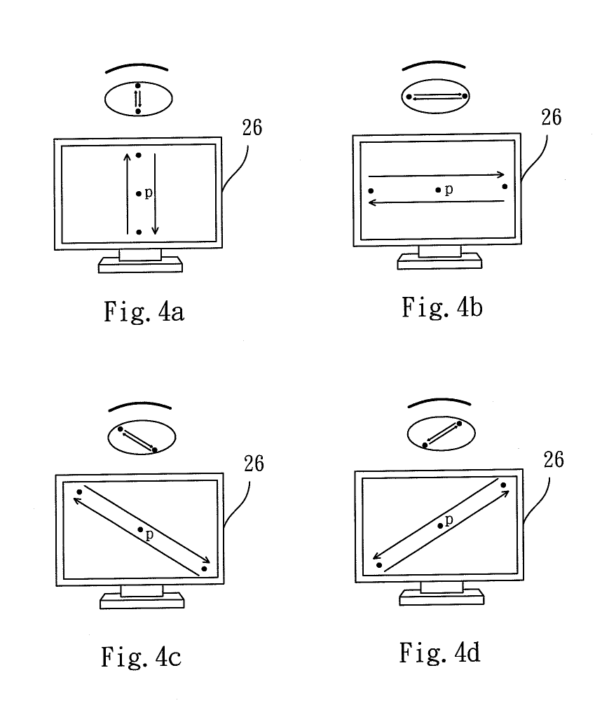

Next introduced is how the signal processing unit 24 works out where the user is staring at according to the digital EOG signals and how the signal processing unit 24 switches to a photo where the user can view a sharp image of an object on the display unit 26. Refer to FIGS. 4a-4d schematically showing the initialization steps of an image control system able to detect EOG according to one embodiment of the present invention. Before the system can determine which region of the display unit 26 the user is staring at, the EOG signals must be initialized. Firstly, a reference point p is presented at the picture plane of the display unit 26, functioning as the initialization point where the user stares the display unit 26 for the first time. Herein, the central point of the picture plane of the display unit 26 is used to exemplify the initialization point. As shown in FIG. 4a, the user stares at the reference point p, and then moves his eyeballs top down or bottom up, and finally returns his eyeballs to stare at the reference point p again, whereby are obtained the vertical digital EOG signals. As shown in FIG. 4b, the user stares at the reference point p, and then moves his eyeballs from left to right or from right to left, and finally returns his eyeballs to stare at the reference point p again, whereby are obtained the horizontal digital EOG signals. As the vertical and horizontal digital EOG signals may interfere mutually, the diagonal digital EOG signals are also measured. As shown in FIG. 4c, the user stares at the reference point p, and then moves his eyeballs from left upper corner to the right lower corner or from the right upper corner to the left lower corner, and finally returns his eyeballs to stare at the reference point p again, whereby are obtained the diagonal digital EOG signals. Via the measured EOG signals can be obtained the relationship between the distances of the eyeball movements and the regions of the picture plane of the display unit 26.

The signal processing unit 24 uses the vertical, horizontal and diagonal digital EOG signals and the coordinates of the initialization point to work out the position where the user is staring in an interpolation method expressed by equations:

$$x = a ( {s}_{h} - {H}_{1} ) ( \frac{X}{{H}_{0} - {H}_{1}} ) + b ( {s}_{v} - {V}_{1} ) ( \frac{Y}{{V}_{0} - {V}_{1}} )$$

$$y = c ( {s}_{v} - {V}_{1} ) ( \frac{Y}{{V}_{0} - {V}_{1}} ) + d ( {s}_{h} - {H}_{1} ) ( \frac{X}{{H}_{0} - {H}_{1}} )$$

wherein sₕ and sᵥ are respectively the digital EOG signals of the horizontal and vertical movements, X and Y the resolutions of the display unit 26, x and y the coordinates of the point the user is staring at, H₀, H₁, V₀, V₁ the initial digital EOG signals, a, b, c, d the weighting factors of the digital EOG signals.

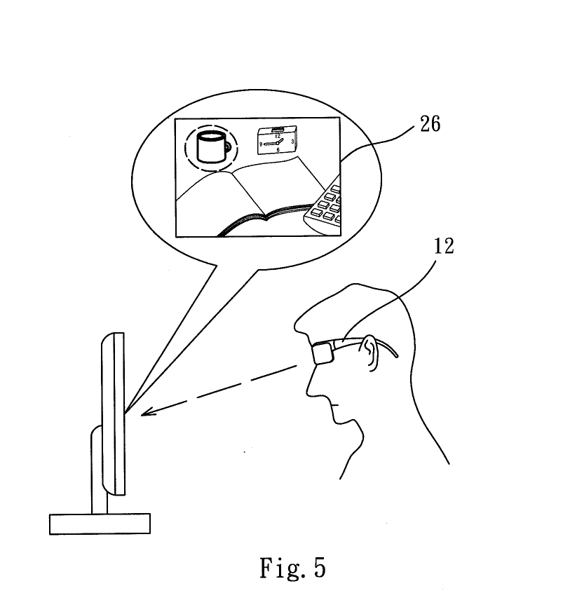

After the abovementioned initialization process has obtained the initialization data, the user needn't perform initialization any more. The ready initialization data can be directly utilized in each succeeding operation. The ready initialization data and the digital EOG signals are used to work out the coordinates of the stared position on the picture plane, and then the display unit presents a sharp image of the objects at the stared position. As shown in FIG. 5, the user is staring_at the cup in the photo presented on the display unit 26; according to the stared position, the signal processing unit 24 retrieves from the storage unit a photo, which is captured in the same scene by focusing the camera on the cup, and then presents the sharp image of the cup on the display unit 26. Thereby, the present invention can switch to photos having different focusing distances according to the stared positions. When the user views the photo presented on the display unit, where he is staring at always has a sharp image. Therefore, the present invention makes the user enjoy the feeling of watching real objects although he is viewing the photo presented on the display unit in fact.

In conclusion, the present invention uses convenient-to-wear eyeglasses to detect the EOG signals of the user, whereby to make the presented photo always suitable for the user's vision and have the optimized visional quality. Further, the present invention may also function as a human-machine interface in many fields, such as 3D images, video, biomedicine, and thus can convenience the living.

Furthermore, the present invention enables the persons, who are disabled to undertake actions in ordinary life, such as those cannot express themselves with oral language or body language but have clear consciousness, to use eyeball movements to intercommunicate with others, make instructions or control some apparatuses without external assistance. Therefore, the present invention should benefit the disabled greatly and have very high potential in the market.

The embodiments described above are only to exemplify the present invention but not to limit the scope of the present invention. Any equivalent modification or variation according to the spirit of the present invention is to be also included within the scope of the present invention.

What is claimed is:

1. An image control system able to detect electrooculography, comprising
an electrooculography detection device including
an eyeglass frame;
a dry electrode module arranged in said eyeglass frame and detecting analog electrooculography signals of a user;
a signal control module arranged in said eyeglass frame, electrically connected with said dry electrode module, amplifying said analog electrooculography signals, converting said analog electrooculography signals into digital electrooculography signals, and then outputting said digital electrooculography signals; and
an external signal processing device including
a storage unit storing a plurality of pieces of image information;
a signal processing unit electrically connected with said storage unit, working out a region being stared at by said user according to said digital electrooculography signals, retrieving from said storage unit a piece of image information containing a sharp image corresponding to said region being stared at by said user; and
a display unit electrically connected with said signal processing unit and presenting said piece of image information containing said sharp image.

2. The image control system able to detect electrooculography according to claim 1, wherein said dry electrode module has at least two first dry electrodes at least two second dry electrodes, and a reference dry electrode, and wherein said two first dry electrodes are respectively arranged in a left side and a right side of said eyeglass frame to detect said analog electrooculography signals of horizontal movements, and wherein said two second dry electrodes are respectively arranged in an upper side and a lower side of said eyeglass frame to detect said analog electrooculography signals of vertical movements, and wherein said reference dry electrode functions as a ground electrode.

3. The image control system able to detect electrooculography according to claim 2, wherein said analog electrooculography signals of horizontal and vertical movements are respectively worked out from potential differences of said two first dry electrodes and said two second dry electrodes.

4. The image control system able to detect electrooculography according to claim 1, wherein said signal control module further comprises
an amplifier amplifying said analog electrooculography signals;
an analog-to-digital converter electrically connected with said amplifier and converting said analog electrooculography signals amplified into digital electrooculography signals; and
a wireless signal transmitter electrically connected with said analog-to-digital converter and transmitting said digital electrooculography signals to said external signal processing device wirelessly.

5. The image control system able to detect electrooculography according to claim 4, wherein said wireless signal transmitter is a WiFi transmitter or a Bluetooth transmitter.

6. The image control system able to detect electrooculography according to claim 1, wherein said external signal processing device further comprises a wireless signal receiver electrically connected with said signal processing unit, receiving said digital electrooculography signals wirelessly, and outputting said digital electrooculography signals to said signal processing unit for succeeding signal processing.

7. The image control system able to detect electrooculography according to claim 6, wherein said wireless signal receiver is a WiFi receiver or a Bluetooth receiver.

8. The image control system able to detect electrooculography according to claim 1, wherein said image information for an identical scene further comprises a plurality of image information respectively captured for said identical scene with different focusing distances.

9. The image control system able to detect electrooculography according to claim 1, wherein said signal processing unit uses said digital electrooculography signals of vertical, horizontal and diagonal movements and initial coordinates to work out a position said user is staring at in an interpolation method expressed by equations:
$$x = a ( {s}_{h} - {H}_{1} ) ( \frac{X}{{H}_{0} - {H}_{1}} ) + b ( {s}_{v} - {V}_{1} ) ( \frac{Y}{{V}_{0} - {V}_{1}} )$$
$$y = c ( {s}_{v} - {V}_{1} ) ( \frac{Y}{{V}_{0} - {V}_{1}} ) + d ( {s}_{h} - {H}_{1} ) ( \frac{X}{{H}_{0} - {H}_{1}} )$$
wherein sₕ and sᵥ are respectively said digital electrooculography signals of vertical and horizontal movements, X and Y resolutions of said display unit, x and y coordinates of a point said user is staring at, H₀, H₁, V₀, V₁ initial digital electrooculography signals, a, b, c, d weighting factors of said digital electrooculography signals.

10. The image control system able to detect electrooculography according to claim 9, wherein said initial coordinates are coordinates of a position of said display unit where said user stares for the first time.
